(19) United States
(12) Patent Application Publication
(10) Pub. No.: US 2011/0004360 A1
(43) Pub. Date: Jan. 6, 2011

(54) METHOD AND CONTROLLER FOR IMPACT DETECTION FOR A VEHICLE

(76) Inventor: Josef Kolatschek, Weil Der Stadt (DE)

Correspondence Address: KENYON & KENYON LLP, ONE BROADWAY, NEW YORK, NY, 10004, US

(21) Appl. No.: 12/734,058

(22) PCT Filed: Sep. 19, 2008
(86) PCT No.: PCT/EP2008/062503

§ 371 Date: Sep. 23, 2010

(30) Foreign Application Priority Data
Oct. 11, 2007 (DE) 102007048883.3

(51) Int. Cl. G06F 19/00

(52) U.S. Cl. 701/1

(57) ABSTRACT

A control device and a method for impact detection for a vehicle are proposed, the impact being detected as a function of a signal of a structure-borne noise sensor system. However, an impact location on the vehicle is determined as a function of an evaluation of a multipath propagation of the structure-borne noise signal in the vehicle.

### BACKGROUND OF THE INVENTION

1. Field of the Invention

The present invention relates to a method and to a control device for impact detection for a vehicle.

2. Description of Related Art

From published German patent document DE 10 2004 022 834 A1, it is known to use structure-borne noise signals for impact detection.

### SUMMARY OF THE INVENTION

In comparison therewith, the method according to the present invention and the control device according to the present invention for impact detection for a vehicle have the advantage that, without additionally generating an item of directional information, the location of the impact can be determined from such an undirected (and thus measured in scalar fashion) structure-borne noise signal, taking advantage of the multipath propagation of the structure-borne noise signal. Multipath propagation is characteristic of the propagation of a structure-borne noise signal, for example in the floor pan as a body part of the vehicle. At the structure-borne noise sensor system, a superposition then occurs of the individual signal portions propagated via the various paths. From this multipath information, it is possible to reconstruct the location of the impact, because these signal portions traveling along the individual paths traveled by the components of the structure-borne noise signal, for example in the floor pan, have experienced a characteristic imprint and temporal displacement that reflects their geometry, making it possible to infer the impact location through back-calculation.

In this way, additional sensors that would otherwise have supplied the directional information can advantageously be omitted. In particular, impact sensors in the front of the vehicle or at the sides of the vehicle can be omitted, thus resulting in a simple savings.

With the method or control device according to the present invention, it is possible to determine the crash geometry, i.e. the location of a collision of an external body with the vehicle structure, in the shortest time, for example in less than two milliseconds, so that the present invention provides timely impact detection.

In addition to the external sensors, however, centrally installed acceleration sensors can also be done without as a result of the method or control device according to the present invention.

In addition, as follows from the independent claims, it is also possible to determine the severity of the crash on the basis of the signal from the structure-borne sensor system. In this way, the method according to the present invention makes it possible for the control device according to the present invention efficiently to trigger passenger protection means, because both the impact location and thus also the type of crash and the severity of the crash can be determined precisely, so that an adapted triggering of passenger protection means, such as airbags or safety belts, can be achieved.

In the present context, a structure-borne noise sensor system is to be understood as a sensor system that is capable of acquiring high-frequency oscillations, in the range of for example between 2 and 100 kHz, within the vehicle structure, because these structure-borne noise oscillations may arise in the case of an impact. The structure-borne noise can be acquired by acceleration sensors that are micromechanically manufactured, but also by magnetostrictive sensors. In the present context, a sensor system may be understood as comprising a plurality of sensors or also only one sensor. In reaction to the structure-borne noise signal, the sensor produces an electrical signal for further processing. This signal represents the structure-borne noise signal.

In the present context, an impact is to be understood as a collision of the vehicle with an impact object.

In the present context, the signal is understood to be a single signal or also a multiplicity of signals. In particular, this signal represents a plurality of multipath components that are superposed at the structure-borne noise sensor.

In the present context, the evaluation is understood as the analysis of the multipath propagation on the basis of the signal; i.e., the impact location is inferred back from the multipath propagation.

For example, the multipath propagation is to be understood as in the case of radio waves, where, in the present context, structure-borne noise propagates in the structures of the vehicle along multiple paths from the impact location to the sensor as a wave. The wave itself can have a longitudinal, transversal, or torsion-type nature, or can be a superposition of these types.

In the present context, a control device is to be understood as an electrical device that processes the signal of the structure-borne noise sensor system and detects the impact as a function thereof. In a development, the control device is in particular also provided in order to trigger passenger protection means, such as airbags or safety belts. Protective means for vehicles may likewise also be triggered by the control device. For this evaluation, the control device has an evaluation circuit such as a microcontroller or some other processor, or an ASIC or a discrete circuit. Dual-core processors may also be used here. If a processor type is used, this processor may run one or more processes for the evaluation.

The interface can be realized as software and/or as hardware. In a hardware realization, in particular an integrated circuit, a multiplicity of integrated circuits, a measurement using discrete components, or a purely discrete solution is possible. However, a software interface is also possible, for example implemented on the microcontroller of a control device.

The multipath module can likewise be realized as hardware and/or as software. In a hardware solution, the multipath module can for example be a separate circuit area of the evaluation circuit. The multipath module can however also be a pure software module.

The impact location is the location at which the structure-borne noise signal originates in the respective body part. This is usually the location at which the impact between the impact object and the vehicle takes place.

The measures and developments indicated in the dependent claims enable advantageous improvements of the method or control device indicated in the independent patent claims for impact detection for a vehicle.

It is advantageous that this evaluation is carried out in that for each impact location, for example divided into path intervals on the edge of a floor pan, the respective delay times corresponding to the possible paths of transmission to the sensor are calculated ahead of time and are stored in the control device. This provides for each impact location a particular characteristic reference sequence of delay times caused by the various possible paths of different lengths along which the signal can travel from the impact location to the sensor location. By summing the measured signal amplitudes for the stored delay times for each of these individual sequences, a sum signal is produced. The sequence with which the largest sum signal is produced is then the one that corresponds to the actual impact location. Advantageously, this method can be applied continuously. For this purpose, it is simply used in sliding fashion, analogous to a window integral, but here for example only three values are summed in each case.

The evaluation advantageously takes place in such a way that the multipath propagation of the signal is detected using a pattern recognition, delay times being determined for the respective paths, and the impact location being determined as a function of these delay times. There is a fixed relation between the location of the origin of the signal, the location of the structure-borne noise sensor system, and the travel path of the primary and of the first and second reflected signal, as well as the further reflected signals. If a particular pattern occurs in the original signal, it will first reach the structure-borne sensor system with the primary wave. The same pattern will also reach the structure-borne sensor system via a path having a reflection, but it will arise somewhat later in time due to the longer travel path. This pattern will reach the sensor via the third path at a point still later in time. Higher-order reflections then follow. Thus, the signal pattern is represented at least three times at different times in the structure-borne sensor system. If these delay times are determined using a correlation mechanism that is capable of detecting the repetition of the first signal pattern in the received signal, the origin location results directly from simple geometric equations. For example, given signal propagation in the floor pan of a vehicle it can be assumed that the first signal has arrived at the sensor along a direct path, i.e. in a straight line. The second signal is reflected once and therefore has traveled a longer path. From the known propagation speed c of the wave, which is a property of the material used, and the time difference t, the equation s=c*t can be used to calculate the path difference between the two signal paths. It can be assumed that on the one hand the impact signal emanates from the edge of the floor pan, while on the other hand the reflection also takes place at the edge of the floor pan. The generally known law of reflection is then additionally used, which states that given a reflection on the outer edge of the pan, the angle of incidence must be equal to the angle of reflection. Taken together, these conditions make it possible to unambiguously determine the impact location.

The time delay is thus characteristic for the location of the origin at the edge of the floor pan. However, this method can be applied only if the location of installation is not situated on one of the lines of symmetry of the pan, because in this case ambiguity of the location of the origin may be present.

Advantageously, the evaluation takes place in such a way that the signal is time-reversed, and the impact location is determined using a computing model for at least one body part on the basis of the time-reversed signal.

Through this time reversal, the signal can take place through a back-projection via the computing model, for example via a finite element model (FEM), a Gitter-Boltzmann model, or a simplified mathematical model, to the signal origin. Through the effect of the time reversal, in the computing model a constructive superposition of the signal sequence, fed in in time-reversed fashion, will take place at the location of origin of the signal. In this way, in the present case a significantly higher amplitude will be recognizable than at all other locations. In this way, it is possible on the one hand to determine the location of origin of the structure-borne noise signal, and on the other hand a reconstruction of the signal at this location is obtained as something like a virtual measurement value without requiring the use of a sensor system at this location. In this way, it is possible with this method, using one or more structure-borne noise sensors, to determine the crash geometry and in addition also to reconstruct the structure-borne noise signal at a point close to the impact location. An evaluation of these two items of information together allows for a triggering of passenger protection means in the vehicle that is adapted to the type of crash.

Furthermore, it is advantageous that passenger protection means are triggered as a function of this reconstruction signal. This can take place for example through threshold value comparisons, where the threshold value can also be realized adaptively and the adaptation is a function of the signal itself and/or of other parameters.

Furthermore, it is advantageous that the severity of the crash, which influences the triggering, is determined as a function of the reconstruction signal. For this purpose, for example the reconstruction signal can be squared in order to determine a measure of the crash energy. This measure of the crash energy is also compared to a threshold value, for example a likewise adaptively formed threshold value.

Furthermore, it is advantageous that for individual components of the signal resulting from the multipath propagation an attenuation is taken into account. In the computing model this can be compensated by an amplification. This makes the method more precise.

Furthermore, it is advantageous that only one signal whose frequency range has been reduced is used for the evaluation. This reduces the computing expense while nonetheless yielding optimal results.

Furthermore, it is advantageous that the signal is composed of temporally synchronized partial signals of a plurality of structure-borne noise sensors. The temporal synchronization results in a high correlation between these partial signals.

### BRIEF DESCRIPTION OF THE SEVERAL VIEWS OF THE DRAWINGS

FIG. 1 shows a vehicle having the control device according to the present invention.

FIG. 2 shows a software structure on a microcontroller from the evaluation circuit.

FIG. 3 shows a first flow diagram.

FIG. 4 shows a second flow diagram.

FIG. 5 shows various time diagrams.

FIG. 6 shows a third flow diagram.

FIG. 7 shows a schematic representation of a multipath propagation.

FIG. 8 shows a fourth flow diagram.

FIG. 9 shows the time reversal.

FIG. 10 shows a mechanical structure of the vehicle.

FIG. 11 shows a propagation of the structure-borne noise signal.

FIG. 12 shows another representation of the propagation of the structure-borne noise signal.

FIG. 13 shows a floor pan optimized for multipath propagation.

FIG. 14 shows an impact pulse where the occurring structure-borne noise signals at various sensors.

FIG. 15 shows the time-reversed signals of the sensors and the resulting pulse.

FIG. 16 shows another representation of the multipath propagation.

### DETAILED DESCRIPTION OF THE INVENTION

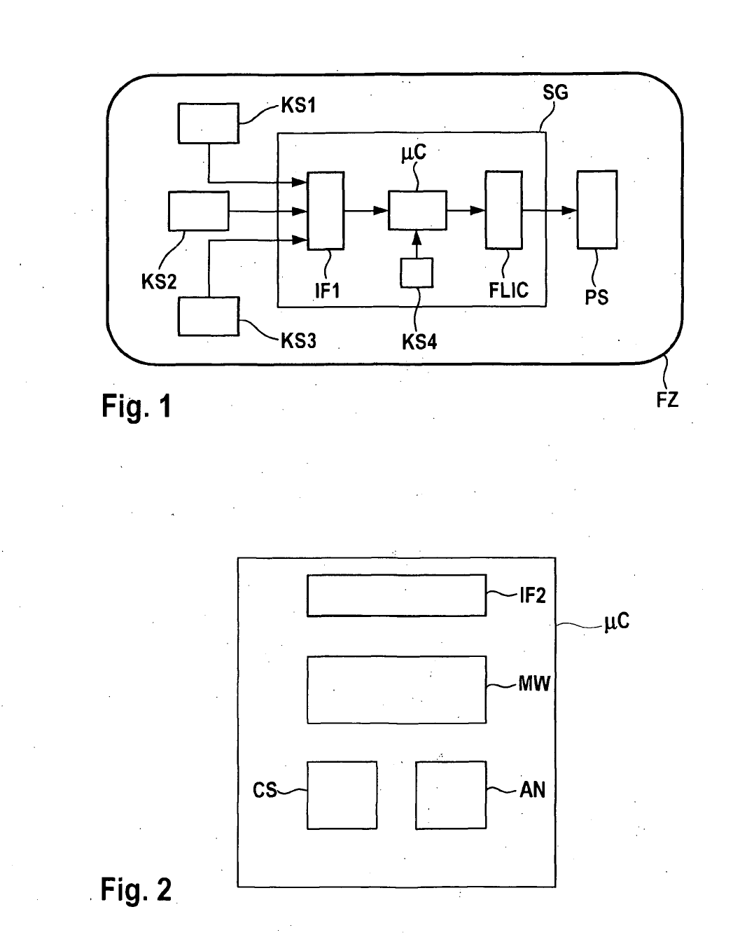

FIG. 1 shows, in a block diagram, the control device SG according to the present invention in a vehicle FZ with connected components of passenger protection means PS, as well as external structure-borne noise sensors KS1 through 3. External structure-borne noise sensors KS1 through 3, which in the present case are micromechanical acceleration sensors, are connected via lines to an interface IF1 of control device SG. In the present example, interface IF1 is fashioned as an integrated circuit. In particular, it is part of a larger integrated circuit that executes further functions for control device SG. From interface IF1, the structure-borne noise signals are transmitted to microcontroller μC from the evaluation circuit. Using the method according to the present invention, microcontroller μC determines the impact location and also preferably determines the severity of the crash. For this purpose, the microcontroller is also additionally connected to a further structure-borne noise sensor KS4 that is situated inside control device SG.

Microcontroller μC uses multipath propagation to determine the impact location on the basis of the analysis of this multipath propagation. The signals that have propagated via the various paths to structure-borne noise sensors KS1 through 4 have characteristic items of information, due to their paths, that permit the original impact location to be reconstructed through a back-projection.

It is possible to use only one structure-borne noise sensor, or to use more or fewer than the indicated structure-borne noise sensors. Further components that are necessary to trigger passenger protection means and the operation of control device SG have been omitted for the sake of simplicity.

Microcontroller μC transmits a corresponding control signal to control circuit FLIC, which has electronically controllable circuit breakers for triggering passenger protection means PS such as airbags, safety belts, and active passenger protection means. Further sensors have also been omitted for the sake of simplicity.

FIG. 2 shows a software structure of microcontroller μC; in the present example, only the software elements required for the understanding of the present invention are shown. Microcontroller μC has an interface IF2 that is used for example for connection to the signals of structure-borne noise sensor KS4. Interface IF2 forwards the signals to multipath propagation module MW in order to reconstruct the impact location, exploiting the multipath propagation, and also in order to determine the severity of the crash from the structure-borne noise signals. Interface IF2 also for example forwards structure-borne noise sensors KS1 through KS3 to multipath propagation module MW. However, the crash severity is determined in module CS, for example by summing the squared, reconstructed structure-borne noise signals in order to obtain a measure for the crash energy. In triggering module AN, a threshold value comparison with the crash severity determines whether, when, and which passenger protection means are to be triggered. The threshold values can be formed adaptively for this purpose.

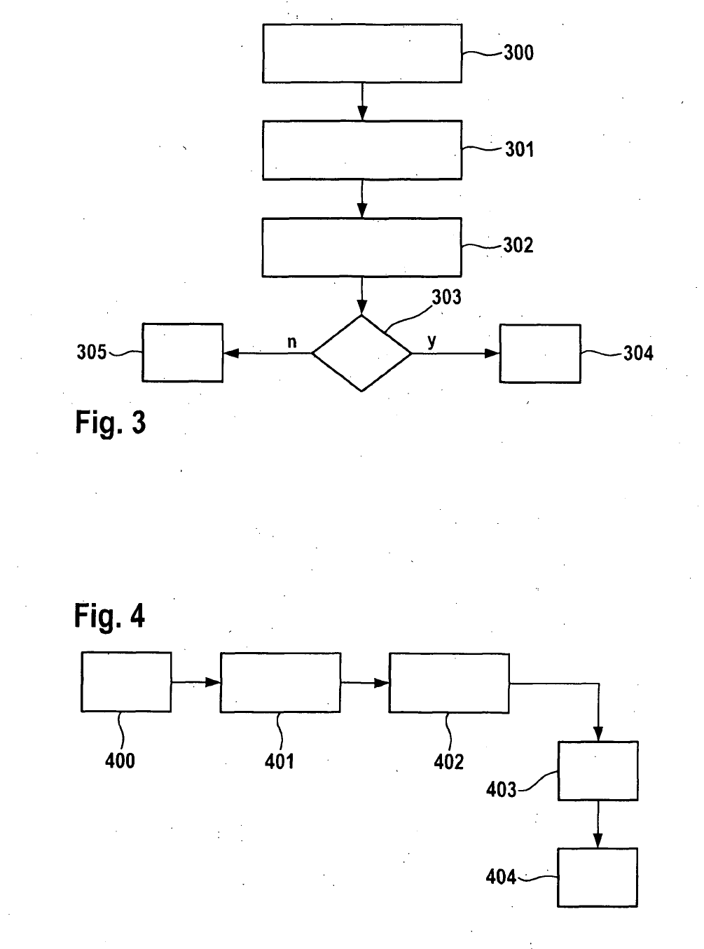

FIG. 3 shows a first flow diagram of the method according to the present invention. In method step 300, the structure-borne noise signals are provided for example through interfaces IF1 and IF2. In method step 301, multipath propagation module MW performs the analysis of the multipath propagation of the structure-borne noise signals, in order in this way to determine the impact location. In method step 302, the crash severity is determined, also on the basis of the structure-borne noise signal. However, for the crash severity a different sensor signal can also be used, either in addition to or in place of the structure-borne noise signal. In method step 303, it is then decided whether, on the basis of the impact location and the crash severity, a triggering of passenger protection means is to be carried out, and if yes, which. This triggering is carried out in method step 304, while if such a triggering is not performed, in method step 305 the method according to the present invention then terminates.

FIG. 4 shows a further flow diagram of the method according to the present invention. In method step 400, the structure-borne noise signals are provided. In method step 401, permanently stored delay times that are characteristic for the various propagation paths are loaded from a memory in the control device. A summation is then carried out with these delay times in method step 402. In method step 403, the maximum of the sums is sought, and in method step 404 the impact location is then allocated to this maximum. This method is relatively simple and can be used as an alternative to the following method.

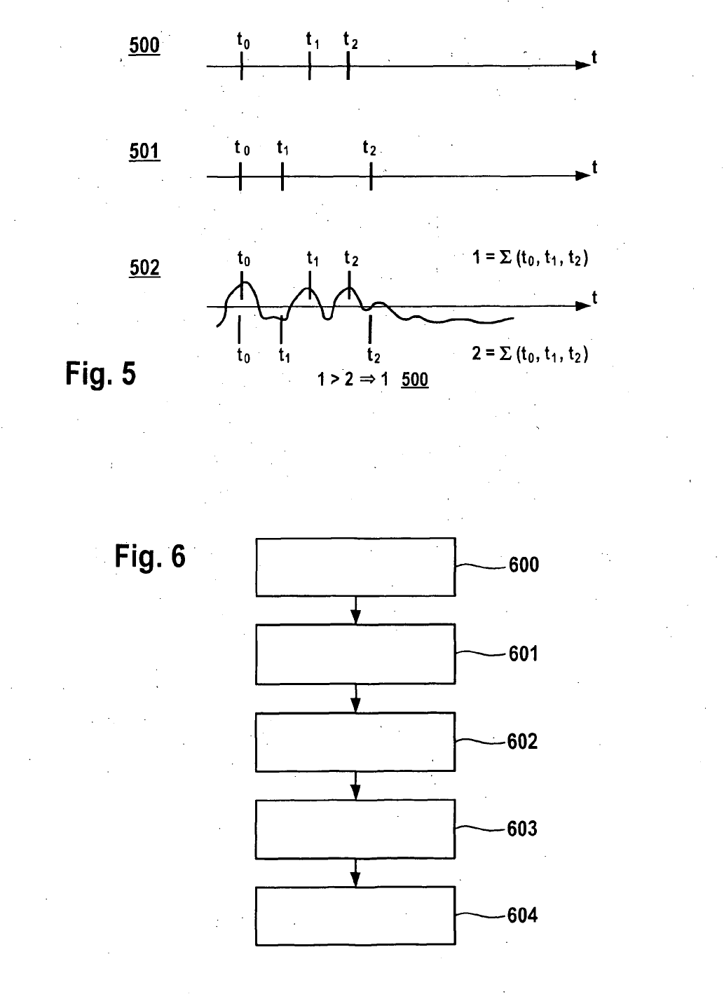

FIG. 5 shows, in three time sequence diagrams 500 through 502, a further explanation of this method. In time diagram 500, the delay times for the first location of origin are represented via delay times t0, t1, and t2, while for a second location of origin of the structure-borne noise sensor system time diagram 501 is used, which likewise indicates times t0, t1, and t2, but at other times than at location of origin 1. Finally, time diagram 502 shows the method according to the present invention. The measured signal 503 is summed at each of the loaded times t0 through t2. As can already be easily seen visually, sum 1 is greater than sum 2. This is represented by the equation S1>S2. Therefore, only origin 500 remains as the location of origin.

FIG. 6 shows a further flow diagram of the method according to the present invention. In method step 600, a pattern is detected in the present signal. In method step 601, this pattern is then also sought in the subsequent received signals. If it is found, then in method step 602 a determination of the delay times is carried out. It is then possible, in method step 603, to carry out an allocation of paths to these delay times.

On the basis of the paths, as a function of the delay times, in method step 604 the impact location can be determined for example using simple geometric equations.

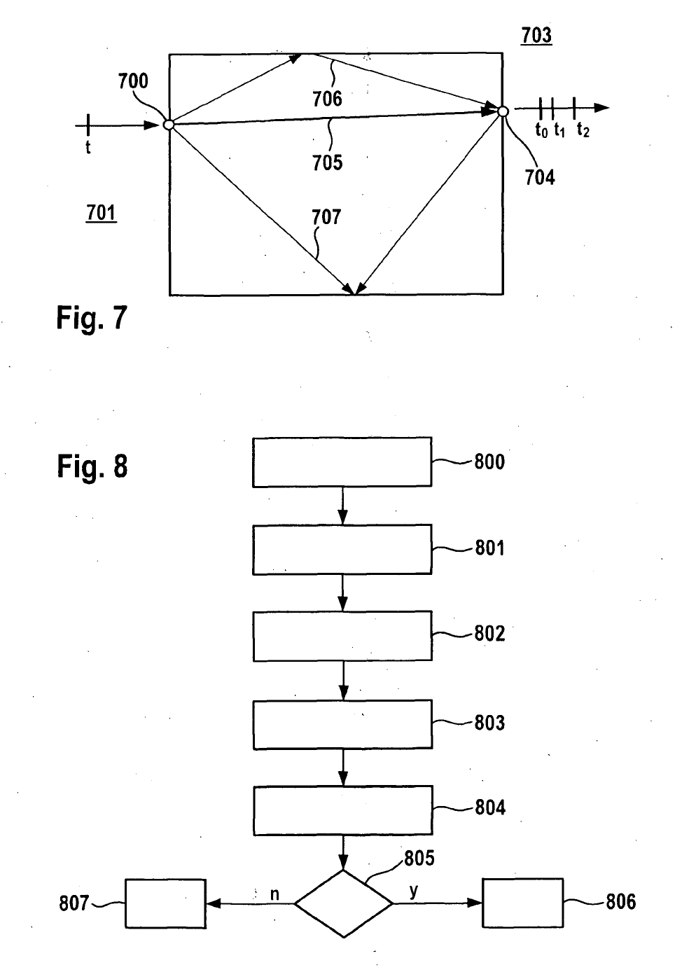

FIG. 7 shows the basis for this method. The structure-borne noise signal arises at point 700, which is therefore the impact location. The signal occurring here has a signal pattern 701. Three paths to receiver 704 are shown: 705, the direct path; 706, via a reflection; 707, also via a reflection. Thus, the signals arrive at receiver 704 at different times. On the basis of the delay times determined according to the present invention, these paths can be determined, and thus the location of origin can be determined. On the basis of the time diagram, it is recognized that the signal pattern, which can be determined for example using correlation techniques, was repeated three times.

FIG. 8 shows a further flow diagram of the method according to the present invention. In method step 800, structure-borne noise sensor system KS1 through KS4 receives the structure-borne noise signals that have also propagated as a result of the multipath propagation. A filtering of these received signals is possible in order to accelerate and to simplify the subsequent calculation. The time reversal takes place in method step 801. Time reversal means that the signals that arrive first now go into the computing model last. In the present case, in method step 802 a floor pan is used on which the structure-borne noise signals are situated. For this floor pan, a computing model, for example a finite element model, is used. Standardly, such a model is already present at the vehicle manufacturer before the beginning of the actual manufacture, and geometrically images the component structure with the aid of discrete shell or volume elements. In addition, this model also contains data concerning the materials used, so that rigidities and the phenomenon of wave propagation can be calculated using these data. The precision of the calculation is a function of, inter alia, the size and number of the elements used. For example, if a lower degree of precision is sufficient in the detection of the impact location, the elements can be selected larger and in a lower number, simplifying the calculation. With this computing model, the time-reversed signals are used to determine the location of the impact. This is carried out in method step 803 by selecting the maximum of the reconstructed signals or reconstruction signals, this maximum indicating the impact location. As an alternative method, the Gitter-Boltzmann method can also be used. The Gitter-Boltzmann method is based on a cellular automaton. Here, for example, the base pan is divided into a fixed raster of cells, and information concerning wave propagation speed and reflection behavior is allocated to each individual cell. In the calculation, it is necessary only that each cell exchange information with its immediate neighbors. In comparison with the FEM method, the Gitter-Boltzmann method has the advantage of numerical simplicity. A description of this method can be found for example in Dieter A. Wolf-Gladrow: Lattice-Gas Cellular Automata and Lattice Boltzmann Models—An Introduction; 308 pp.; Springer 2000. The method can also be implemented directly in an electronic circuit. Thus, a raster of memory and computing elements can be situated on an electronic component, directly representing the vehicle component. The individual raster elements on the component are then each connected to their immediate neighbor corresponding to the rules of the raster-Boltzmann method. In a particular raster cell, corresponding to the location of the sensor on the floor pan, the time-reversed signal is fed in at the component. At the edge of this raster, there are outputs at which the edge signals can be picked off, and the maximum can be determined correspondingly. The adaptation of such a component to a particular vehicle can for example proceed in such a way that in each raster cell particular writable memory cells are provided that contain information concerning the local wave propagation speed, or concerning whether the raster element is one situated at the edge of the pan, is an input or output element, or is an element that is excluded from the computation. A floor pan having a particular size can then easily be modeled on the electronic component by setting the corresponding memory contents on the raster. An electronic component realized in this way has the advantage of high computing speed and simple operation.

In method step 804, the obtained maximum is squared in order to obtain a measure for the crash severity. In method step 805, it is checked whether the crash severity is high enough, and how high it is, to decide whether or not a triggering is required. If a triggering is required, this takes place according to the specifications in method step 806. If the triggering is not required, then a misuse is for example also recognized in method step 807.

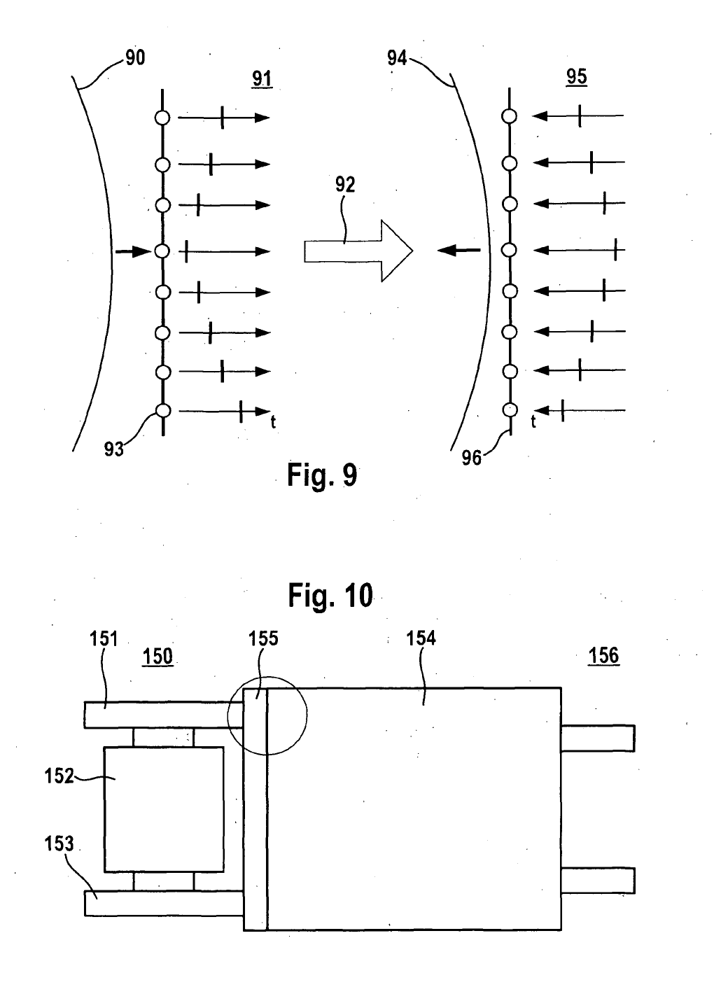

FIG. 9 schematically shows the basic principle of the time-reversal method. From the left, a wave front 90 meets sensors 93. The arrival of the wave front is registered by each of the individual sensors 93 as a function of time. Because wave front 90 is curved, this is a wave emanating from a point source. Therefore, the wave arrives at the various locations of sensors 93 at different times. This is seen clearly in the position of the signals on the time axis for the respective sensors. This is identified by reference character 91.

In the next step, measurement values 91 are now inverted on the time axis; i.e., the pulse that previously was early on the time axis is now late, and vice versa. These signals are given to emitters 96, each emitter 96 being situated at the position of the corresponding sensor. There they are emitted in the sequence that is the reverse of that of their arrival. This is indicated by outgoing wave 94.

There results a time-mirrored version of the received wave; i.e., the resulting wave is to be received identically, with only the direction of movement reversed; i.e., from the previously divergent wave, a convergent wave is produced that is concentrated back in the direction toward the original point of origin.

Upon each impact of a vehicle, the locally occurring accelerations cause noise waves that propagate going out from the point of impact, and that propagate through the entire connected vehicle structure. These waves move with the local speed of sound, which for example for steel is approximately 5000 meters per second.

FIG. 10 shows the point of entry into floor pan 154. The entry point thus stands in direct relation to the location of the impact—in the present case, the front right side member 151—and thus permits detection of the crash geometry. In the case of a frontal crash having a left offset, for example, the signal is introduced in the left front region of the floor pan. The same holds correspondingly for side crashes and rear crashes. For the sake of simplicity, in the following descriptions only the floor pan is considered, because the point of entry of the signal into the floor pan characterizes the crash geometry with sufficient precision. Body parts other than the floor pan could also be used. From the point of entry, the structure-borne noise signal now propagates in circular fashion until it meets a boundary surface. At the boundary, the wave is reflected and is thrown back into the interior of the pan. Over the further course of propagation, the original waves are now superposed with the reflected waves, so that interference arises. As the wave propagates further, reflections and waves running back occur at all edges of the pan, so that a complicated overall interference structure is formed. In FIG. 10, the point of impact is indicated by arrow 155 on the side member. The structure-borne noise signal will propagate into floor pan 154 via the side member and the separating wall. In the region identified by a circle, the transition to the floor pan takes place. The rear part of the vehicle is designated 156 and the front part is designated 150. The engine is designated 152, and the left side member is designated 153. The front part of the vehicle is designated 150.

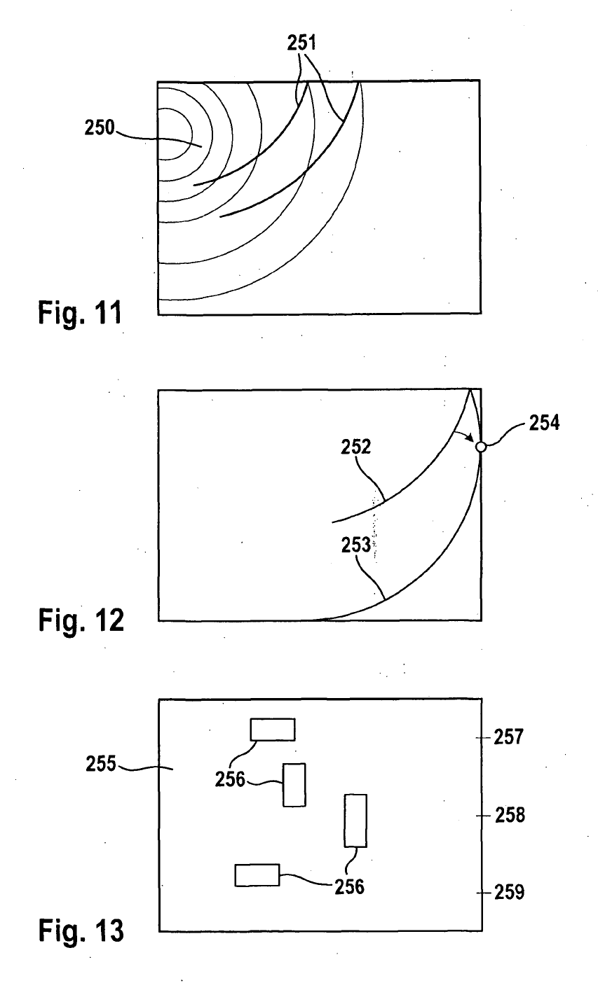

FIG. 11 shows a schematic representation of a floor pan. The circular structures represent the propagating structure-borne noise waves. This is identified by reference character 250. Lines 251 designate the secondary waves arising at the edge of the floor pan through reflection of the original wave. For the sake of simplicity, only some of the wave trains are shown.

If structure-borne noise sensors are fastened to the floor pan, over time they will measure not only the primary wave but also all reflected waves as soon as they arrive, as superposition of the measurement positions.

At measurement point 254, shown in FIG. 12, wave train 253 will thus first arrive, and after a short time will be superposed by wave train 252, which originates from the first reflection and arrives somewhat later. The subsequent wave trains are not shown for the sake of simplicity. The optional further sensors have also been omitted from the representation.

Overall, therefore, the structure-borne noise sensors register a complicated temporal sequence of signals that arises due to the superposition of primary and reflected waves.

The recorded sensor signal at first does not contain any information about the direction from which the signal arrives. In fact, as already described, the signal arrives from various directions.

However, using the time-reversal principle, according to this specific embodiment the location of the emission of the structure-borne noise signal can nonetheless be determined. For this purpose, in a first step the recorded signals are time-inverted. In the next step, this signal is fed into a computing model of the floor pan, in such a way that in the model the corresponding waves are fed in precisely at the locations of the sensors. Subsequently, the computing model is used to calculate the propagation of the waves, and it is determined where the highest signal intensity occurs at the edge of the floor pan. The location of the highest signal intensity corresponds to the location from which the structure-borne noise waves entered into the floor pan.

FIG. 13 shows another floor pan having an impact location 255 and having sensors 257, 258, and 259. On the floor pan, obstacles 256 are built in, as are present in a real floor pan for example due to bores, screw points for seats and restraints, or shaping (beading). As a result of these obstacles 256, the method according to the present invention functions still better. Drawing an analogy with optics, it can be said that such obstacles, because they represent centers of the wave scattering, increase the opening angle of the system and thus increase the resolution capacity. Given a suitable construction, it is thus entirely possible to use the method even with a single structure-borne noise sensor.

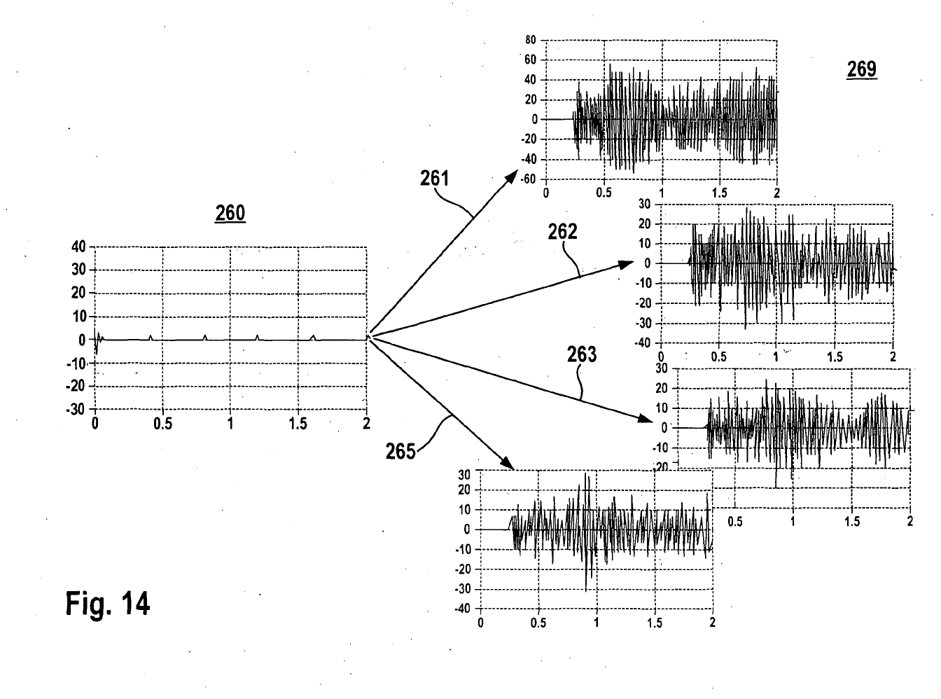

FIG. 14 schematically shows what happens at the individual sensors to a pulse that enters into the floor pan, designated 260, as a result of multipath propagation. Sensor data 264 differ very strongly from pulse 260; here, four different sensor data 261, 262, 263, and 265 are shown. The cause of this is the multipath superposition.

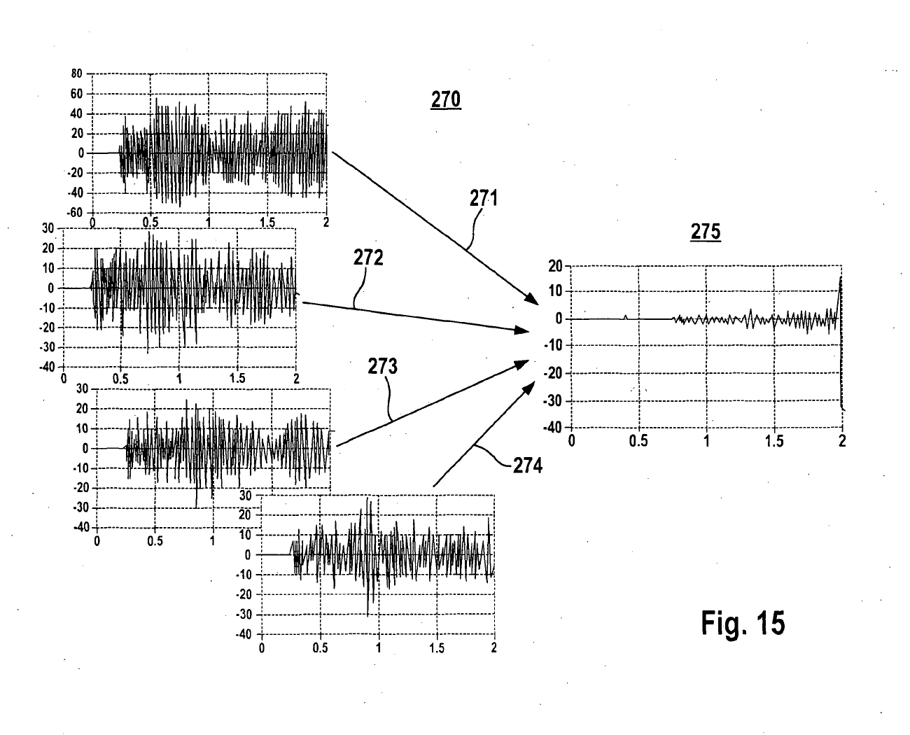

FIG. 15 shows the following step. From the sensor signals, time-reversed signals 270 or formed, and signals 271 through 274 are then supplied to the computing model, and resultant pulse 275 is formed. The signals are each shown in an amplitude time diagram in FIGS. 14 and 15. Here, for example the reconstruction of the pulse on the basis of the structure-borne noise signals is shown.

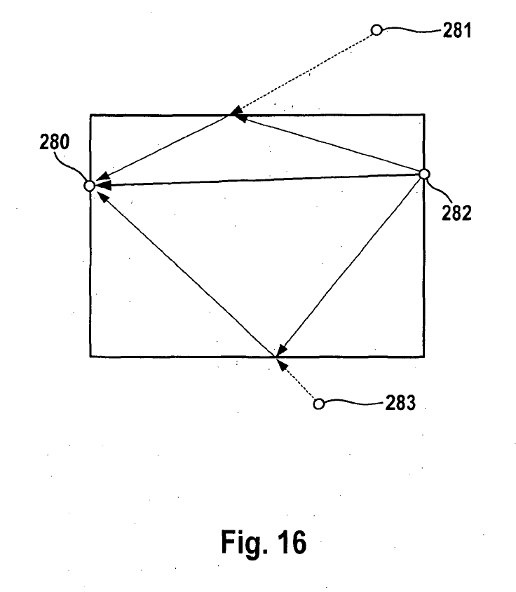

Given a plurality of structure-borne noise sensors, the expense is disadvantageous due to the large number of structure-borne noise sensors. If one is willing to be satisfied with a somewhat lower degree of precision in the determination of the impact location, a single structure-borne noise sensor is sufficient to determine the crash geometry. However, it is then absolutely necessary that the signal be scattered or reflected at least once, preferably multiple times, and that the correspondingly scattered and reflected signals reach the structure-borne noise sensor system. Here advantage is taken of the fact that the reflected signals on the one hand have traveled a different path, and on the other hand contain information from an originally different direction. From signal origin 280 in FIG. 16, the location on the floor pan from which the crash signal went out, reflected signals radiated in in time-inverted fashion appear as if they were emitted from an additional emitter 281 and 283. This can be well-illustrated in a representation analogous to ray optics. Rays are understood here as lines that run perpendicular to the wave trains and in the direction of propagation. When ray optics is applied, the law of reflection holds, according to which the angle of incidence equals the angle of reflection. FIG. 16 shows emitter 282 and virtual emitters 281 and 283, and origin 280.

A signal that is reflected back to the origin on various paths can thus partly compensate the omission of sensors while still permitting a usable reconstruction of the original signal. Under some circumstances, it makes sense to increase the reconstruction quality by installing additional scatter and reflection centers. These can be for example beads or holes in the pan.

In sum, it can be said that, perhaps contrary to an intuitive assumption, the method functions better the more obstacles there are in the signal path, because they characterize this signal path.

An increase in the reconstruction quality can take place by including a possible attenuation of the wave signal in the reconstruction. Differing propagation paths of the signals having different angles of view result, through signal attenuation, in a change in the signal amplitudes. In the time-reversal calculation, this effect can be compensated by a suitable computational method. For example, for the propagation of the wave an amplification can be used in the calculation instead of an attenuation. Here, for example in each time step the signal is increased by a particular amount, where this amount can be a function of the local material properties and is calculated correspondingly. A signal that has traveled a longer path (and has required a correspondingly longer time to do so) and that was correspondingly strongly attenuated during the temporal forward calculation is in this way amplified again in the time-reversal calculation, proportionally to the time required (and thus proportionally to the path).

1-13. (canceled)

14. A method for impact detection for a vehicle (FZ) using a signal of a structure-borne noise sensor system (KS1 through 4), comprising: determining an impact location on the vehicle (FZ) as a function of an evaluation of a multipath propagation based on a structure-borne noise signal, on the basis of the signal.

15. The method as recited in claim 14, wherein the evaluation is carried out such that reference signals for various possible impact locations are produced by summing the signal with stored delay times, and the largest reference signal indicates the actual impact location.

16. The method as recited in claim 15, wherein the reference signals are produced continuously.

17. The method as recited in claim 14, wherein the evaluation takes place such that the multipath propagation is detected using a pattern recognition, and delay times are determined for each of the paths of the structure-borne noise signal, and the impact location is determined as a function of the delay times.

18. The method as recited in claim 17, wherein a correlation is used for the pattern recognition.

19. The method as recited in claim 14, wherein the evaluation takes place such that the signal is time-reversed, and the impact location is determined using a computing model for at least one body part on the basis of the time-reversed signal.

20. The method as recited in claim 19, wherein using a computing model, the impact location is determined in that for the impact location the computing model determines a maximum reconstruction signal from the time-reversed signals, compared to other locations.

21. The method as recited in claim 20, wherein passenger protection means (PS) are triggered as a function of the reconstruction signal.

22. The method as recited in claim 21, wherein a crash severity, which influences the triggering, is determined as a function of the reconstruction signal.

23. The method as recited in claim 19, wherein an attenuation is taken into account for individual components of the signal.

24. The method as recited in claim 20, wherein an attenuation is taken into account for individual components of the signal.

25. The method as recited in claim 21, wherein an attenuation is taken into account for individual components of the signal.

26. The method as recited in claim 19, wherein for the evaluation the signal is reduced in its frequency range.

27. The method as recited in claim 20, wherein for the evaluation the signal is reduced in its frequency range.

28. The method as recited in claim 21, wherein for the evaluation the signal is reduced in its frequency range.

29. The method as recited in claim 19, wherein the signal is made up of temporally synchronized partial signals of a plurality of structure-borne noise sensors.

30. The method as recited in claim 20, wherein the signal is made up of temporally synchronized partial signals of a plurality of structure-borne noise sensors.

31. The method as recited in claim 21, wherein the signal is made up of temporally synchronized partial signals of a plurality of structure-borne noise sensors.

32. A control device (SG) for impact detection for a vehicle (FZ), comprising:
at least one interface (IF1, IF2) that provides a signal of a structure-borne noise sensor system (KS1 through 4), and
an evaluation circuit (μC) that detects the impact as a function of the signal, wherein the evaluation circuit (μC) has a multipath propagation module (MW) that determines an impact location on the vehicle as a function of a multipath propagation of a structure-borne noise signal.
